(19) United States
(12) Patent Application Publication
(10) Pub. No.: US 2017/0297753 A1
(43) Pub. Date: Oct. 19, 2017

(54) ELECTRICAL VACUUM-PUMPING DEVICE

(71) Applicant: Welcome Co., Ltd., New Taipei City (TW)

(72) Inventor: Richard CHANG, New Taipei City (TW)

(21) Appl. No.: 15/465,646

(22) Filed: Mar. 22, 2017

(30) Foreign Application Priority Data
Apr. 18, 2016 (TW) 105205417

(51) Int. Cl. B65B 31/04; H02J 7/00

(52) U.S. Cl. CPC B65B 31/04; H02J 7/0052; H02J 7/0045; H02J 2007/0062

(57) ABSTRACT

An electrical vacuum-pumping device includes a primary structure body, an upper lid, an electrical vacuum pump, a power source, and a suction nozzle. The primary structure body includes an upper body board and a lower body board which are fastened with each other, and in which an accommodating space is provided. The lower body board is provided with a suction hole for communicating with ambient atmosphere. The electrical vacuum pump is provided with a vacuum-pumping mouth, and is arranged in the accommodating space, and is electrically connected with the electrical vacuum pump. The suction nozzle is fixedly arranged underneath to the lower body board. When in a state of use, the suction nozzle can engage directly with an impermeable cup or a joint at one's option; or engage an object to be vacuum-pumped and then attach the same to the object to be vacuum-pumped.

### BACKGROUND OF THE INVENTION

### Field of the Invention

The present invention relates to an electrical vacuum-pumping device, and more particularly, to an electrical vacuum-pumping device adapted for various kinds of objects to be vacuum-pumped.

### Description of Related Art

For our daily life, containers or bags which help us load or store various kinds of goods, particularly in the application of loading or storing foods and beverages, are widely used. In order to increase storage life of goods so as to prevent the stored goods from being spoiled or rotten, normally an electrical vacuum-pumping device can be employed to perform a vacuum-pumping work such that air can be discharged from the containers.

Currently electrical vacuum-pumping devices are available in the market for various containers, such as the one disclosed in Taiwan Patent Publication No. 503959 relating to an electrical vacuum-pumping device for a sealed jar; or the one in Taiwan Utility Model Publication No. M514447 relating to a vacuum-pumping device for a storage bag. Among them, each particular type of electrical vacuum-pumping device only matches to a singular type of container or storage device, making consumers require to purchase multiple electrical vacuum-pumping devices in order to fit various types of containers or storage devices. This will greatly lower the consumer's desire of purchase and result in a poor portability and efficiency of use. Moreover, the conventional electrical vacuum-pumping device employs a motor structure having an eccentric wheel which occupies a larger volume and makes a greater noise. As such, there still exists room of improvement for the conventional art.

Given the above, in an attempt to solve the problem, as mentioned above, research and experiments for an “Electrical Vacuum-Pumping Device” have been undertaken, eventually resulting in accomplishment of the present invention.

### SUMMARY OF THE INVENTION

An object of the present invention is to provide an electrical vacuum-pumping device, where not only a suction nozzle can contact directly with an object to be vacuum-pumped, but also various kinds of joints can be engaged therewith. As such, the electrical vacuum-pumping device, according to the present invention, can be applied to various products for vacuum-pumping work. This will solve the problem of conventional art that various products require multiple types of vacuum-pumping devices, making the present invention a diversified electrical vacuum-pumping device with multi-functions.

To achieve the above-mentioned object, the electrical vacuum-pumping device comprises a primary structure body, an upper lid, an electrical vacuum pump, a power source, and a suction nozzle. In addition, the electrical vacuum-pumping device, according to the present invention, further comprises an impermeable cup or a joint, for engaging the suction nozzle at one's option.

According to the present invention, the primary structure body includes an upper body board and a lower body board, in which an accommodating space is provided. The lower body board is provided with a suction hole for communicating with ambient atmosphere. The upper lid covers on the upper body board, and normally screws are employed to fasten the same together. The electrical vacuum pump, which is arranged in the accommodating space, is provided with a vacuum-pumping mouth such that the vacuum-pumping mouth extends into the suction hole. As such, air inside of the object to be vacuum-pumped can be pumped into the electrical vacuum pump. Further, the power source, which is also arranged in the accommodating space, is electrically connected with the electrical vacuum pump for driving the same for operation. The suction nozzle is fixedly arranged underneath to the lower body board, and that the suction nozzle encloses the suction hole for attaching to the object to be vacuum-pumped so as to maintain tightness of connection. When in a state of use, the suction nozzle can engage directly with the object to be vacuum-pumped; or to engage the impermeable cup or the joint at one's option, and then attach the same to the object to be vacuum-pumped.

Through the above-mentioned design, it is understand that the present invention is featured in using a miniaturized vacuum pump to replace the conventional art which has the structure of motor with an eccentric wheel, such that in maintaining a certain vacuum suction, the volume occupied and the noise under operation can be reduced effectively, let alone a higher portability is possible. Further, by means of the replaceable joint, the electrical vacuum-pumping device, according to the present invention, can be applied to more products. This not only reduces expenses for users, but also enhances portability of the products, giving the users a feeling of worthiness more than money paid.

According to the present invention, the power source may relate to a rechargeable battery, or a lithium battery. In such a case, the electrical vacuum-pumping device may further comprise a charging panel, where the charging panel is inserted into a charging panel engaging element arranged at the primary structure body, and is electrically connected with the power source. The charging panel engaging element is provided with a charging slot, which, according to the present invention, relates to a USB slot. As such, the electrical vacuum-pumping device, according to the present invention, can carry out a charging work through the USB slot, and that electric power can be converted through the charging panel and then stored in the power source. From such a manner of repeated power supply, convenience of use can thus be enhanced.

Further, according to the present invention, the power source may relate to a disposable battery, or an alkaline battery. In such a case, the power source will be electrically connected with the electrical vacuum pump, and this relates to a well-known manner of power supply, where such a battery has a dimension and weight greater than those of a lithium battery, though the design and structure are simpler and cost can be lowered.

Still further, according to the present invention, the joint relates to a cork joint, or a cupping joint. The joint, when dealing with different objects to be vacuum-pumped, can match different joints for vacuum pumping. Therefore, it is not intended for the present invention to include only the above-mentioned two kinds of joints; but customized design service for the joints is available in compliance with customers' usage habit.

According to the present invention, the primary structure body may be arranged with a switch button for controlling actuation or shutdown of the electric vacuum pump. As such, unlike the conventional art following a push-button measure, the electric vacuum pump, according to the present invention, can perform a lengthy trigger of actuation through the switch button, without the user's lengthy push for actuation by the finger.

Further, according to the present invention, the primary structure body further includes a middle body board interposed between the upper body board and the lower body board, such that more components can be disposed in the primary structure body, including laying more batteries, enlarging the overall space, and increasing spatial arrangement of the primary structure body.

Still further, the suction nozzle may be made of silicon so as to help improve tightness when in contact with the object to be vacuum-pumped, and to prevent air from coming in or out of the gaps of an attaching position during a vacuum-pumping work of the electrical vacuum-pumping device.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view illustrating an electrical vacuum-pumping device according to a first embodiment of the present invention;

FIG. 2 is an exploded view illustrating the electrical vacuum-pumping device according to the first embodiment of the present invention;

FIG. 3 is a schematic view illustrating the electrical vacuum-pumping device according the first embodiment of the present invention in a state of use;

FIG. 4A is a perspective view illustrating an impermeable cup, together with a sealing washer and a sealing washer liner, of the electrical vacuum-pumping device according to the first embodiment of the present invention;

FIG. 4B is a schematic view illustrating a state of use for the electrical vacuum-pumping device incorporated with the impermeable cup according to the first embodiment of the present invention;

FIG. 5A is a perspective view illustrating a cork joint of the electrical vacuum-pump according to the first embodiment of the present invention;

FIG. 5B is a schematic view illustrating a state of use for the electrical vacuum-pumping device incorporated with the cork joint according to the first embodiment of the present invention;

FIG. 6A is a perspective view illustrating a cupping joint of the vacuum-pumping device according to the first embodiment of the present invention;

FIG. 6B is a perspective view illustrating a state of use for the electrical vacuum-pumping device incorporated with the cupping joint according to the first embodiment of the present invention;

FIG. 7 is a perspective view illustrating an electrical vacuum-pumping device according to a second embodiment of the present invention; and

FIG. 8 is an exploded view illustrating the electrical vacuum-pumping device according to the second embodiment of the present invention.

### DETAILED DESCRIPTION OF THE PREFERRED EMBODIMENTS

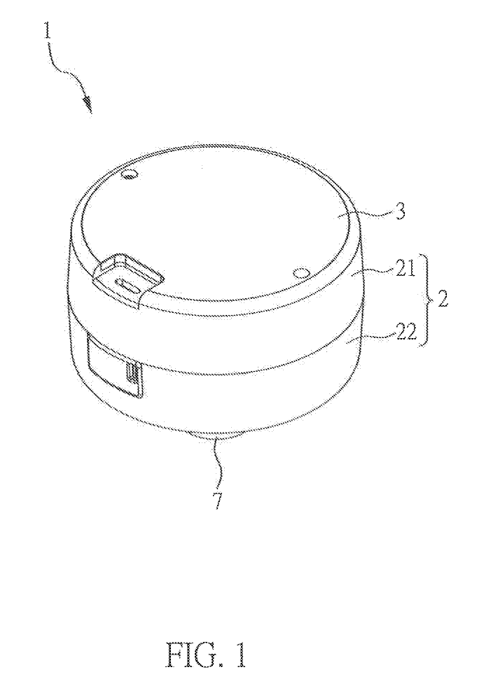

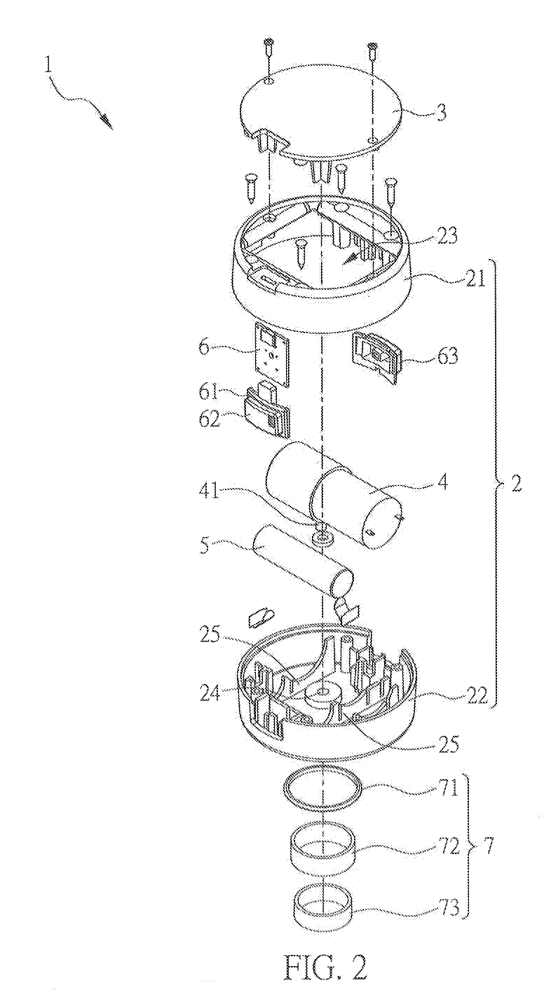

Referring to FIG. 1, a perspective view illustrating an electrical vacuum-pumping device according to a first embodiment of the present invention; and to FIG. 2, an exploded view illustrating the electrical vacuum-pumping device, the electrical vacuum-pumping device 1 comprises a primary structure body 2, an upper lid 3, an electrical vacuum pump 4, a power source 5, a charging panel 6, and a suction nozzle 7.

As shown in FIG. 2, the primary structure body 2 includes an upper body board 21 and a lower body board 22, in which an accommodating space 23 is provided for receiving the electrical vacuum pump 4 and the power source 5. The lower body board 22 is provided with a suction hole 24 and a supporting base 25 for supporting the electrical vacuum pump 4 and the power source 5. Further, the upper body board 21 is fastened with the upper lid 3; and that the lower body board 22 is provided, at its front side and rear side, with a notch, respectively, for mounting a charging panel engaging element 61 and a switch button 63, such that an overall casing structure of the electrical vacuum-pumping device 1, according to the present invention, can therefore be completed.

Thereafter, the following will be focused on a structural design of the primary structure body 2 and a spatial arrangement of the accommodating space 23. The electrical vacuum pump 4, which is arranged on the supporting base 25, is provided with a vacuum-pumping mouth 41 such that the vacuum-pumping mouth 41 extends into the suction hole 24. As such, air inside of an object to be vacuum-pumped can be pumped into the electrical vacuum pump 4, and then the air can be discharged through gaps around the notches at the front and rear sides of the primary structure body 2. Suction devices of air-pumping types are featured in miniaturization and low noise, and such devices can replace the conventional art which has the structure of motor with an eccentric wheel, let alone a higher portability is possible. Further, the power source 5, which is also arranged on the supporting base 25, relates to a lithium battery featured in having a larger output power, no memory effect, and higher frequency of repeated charging and discharging. The power source 5 has its one end connected with the electrical vacuum pump 4, and its other end connected with the charging panel 6. In addition, the charging panel 6 is inserted into the charging panel engaging element 61 which is provided with a charging slot 62, which, according to the present invention, relates to a USB slot. As such, the electrical vacuum-pumping device 1, according to the present invention, can carry out a charging work through the USB slot, and that electric power can be converted through the charging panel 6 and then stored in the power source 5. From such a manner of repeated power supply, convenience of use can thus be enhanced.

According to the present invention, the suction nozzle 7 is fixedly arranged underneath to the lower body board 22, where the suction nozzle 7 includes an O-ring 71, a sealing washer 72, and a sealing washer liner 73 which enclose the suction hole 24, respectively. Both the sealing washer 72 and the sealing washer liner 73 are made of silicon. This will help improve tightness when in contact with the object to be vacuum-pumped so as to prevent air from coming in or out of the gaps of an attaching position during a vacuum-pumping work of the electrical vacuum-pumping device 1.

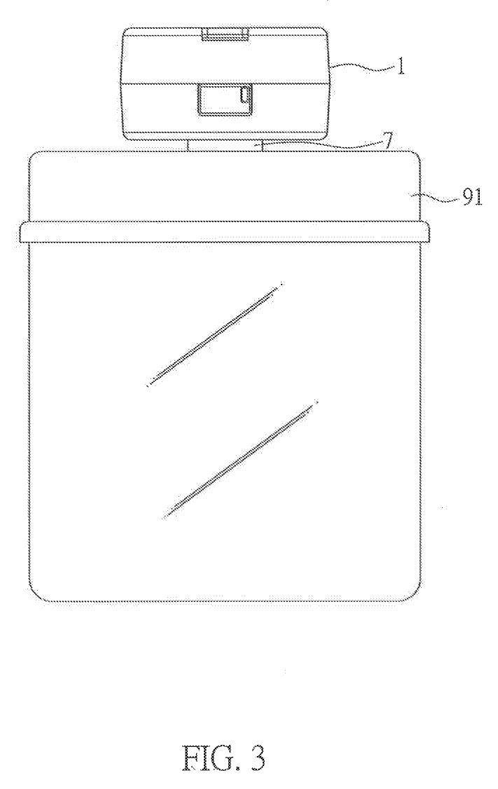

Now referring to FIG. 3, a schematic view illustrating the electrical vacuum-pumping device according the first embodiment of the present invention in a state of use, a sealed jar 91, as an object to be vacuum-pumped, is provided with an air vent (not shown) for proceeding with the vacuum-pumping work for the electrical vacuum-pumped device 1. According to the present invention, the vacuum-pumping work is performed by attaching the suction nozzle 7 to the sealed jar 91 and actuating the switch button 63.

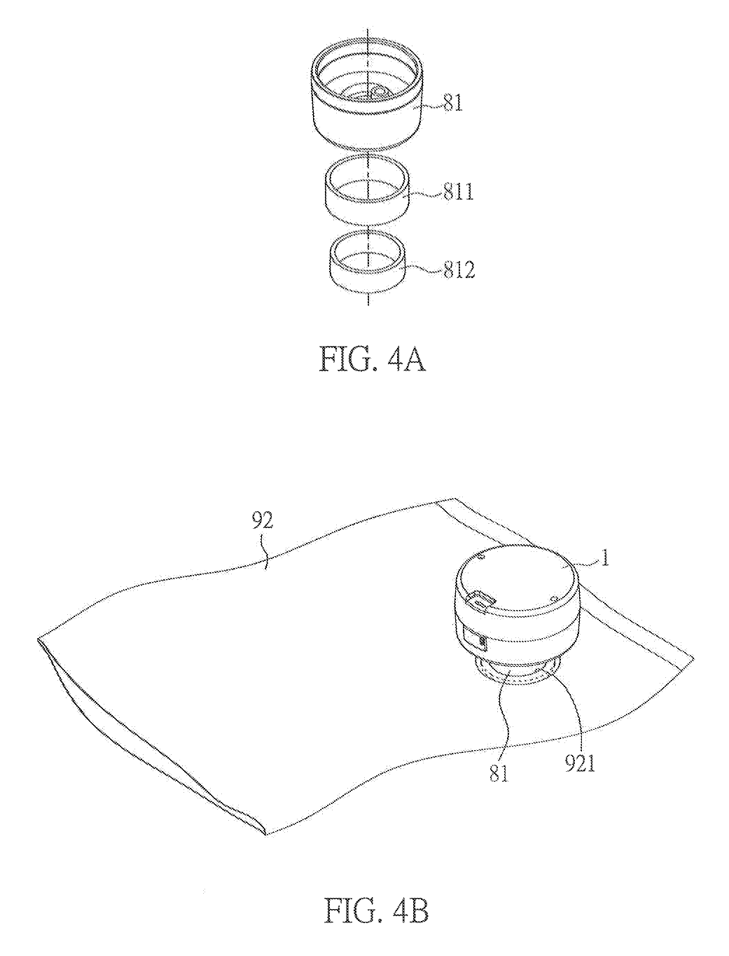

Further, references are made to FIG. 4A, an exploded view illustrating an impermeable cup, together with a sealing washer and a sealing washer liner, of the electrical vacuum-pumping device according to the first embodiment of the present invention; and FIG. 4B, a schematic view illustrating a state of use for the electrical vacuum-pumping device incorporated with the impermeable cup according to the first embodiment of the present invention. A bag 92, which is to be vacuum-pumped, is provided with an air vent 921 for proceeding with a vacuum-pumping work by the electrical vacuum-pumped device 1. The suction nozzle 7 is sleeved with an impermeable cup 81 for isolating vapor suctioned from outside so as to avoid the vapor from entering into the electrical vacuum-pumping device 1 and damaging the same. Further, the impermeable cup 81 is incorporated with a sealing washer 811 and a sealing washer liner 812

Which are made of silicon for enhancing tightness with the bag 92 to be vacuum-pumped. Namely, after attaching the impermeable cup 81 to the air vent 921 of the bag 92, the switch button 63 is turned on for proceeding with the vacuum-pumping work.

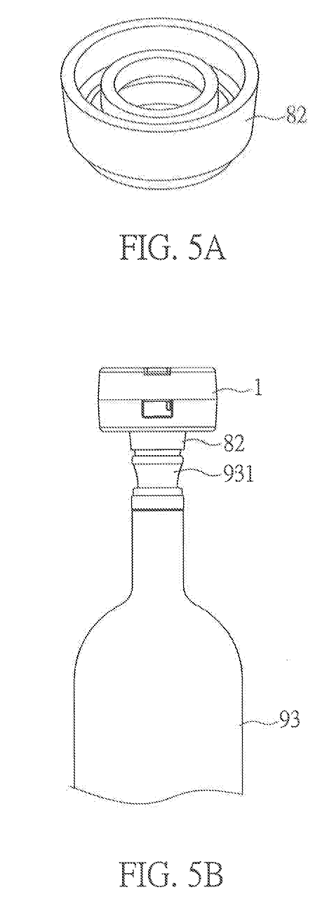

Still further, references are made to FIG. 5A, a perspective view illustrating a cork joint of the electrical vacuum-pump according to the first embodiment of the present invention; and FIG. 5B, a schematic view illustrating a state of use for the electrical vacuum-pumping device incorporated with the cork joint. A bottle 93, which is to be vacuum pumped, has an opening for performing a vacuum-pumping work with the electrical vacuum-pumping device 1. The suction nozzle 7 of the electrical vacuum-pumped device 1 is sleeved with and in the cork joint 82, where the cork joint 82 is dimensioned to match a cork 931 and is made of silicon such that a preferable tightness can be obtained. Accordingly, upon engaging the cork joint 82 with the cork 931, which is inserted into the bottle 93, a vacuum-pumping action can be performed by turning on the switch button 63.

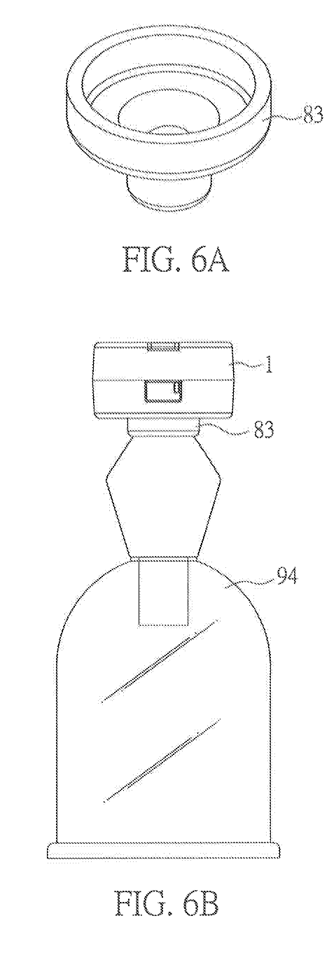

Now references are made to FIG. 6A, a perspective view illustrating a cupping joint of the vacuum-pumping device according to the first embodiment of the present invention; and FIG. 6B, a perspective view illustrating a state of use for the electrical vacuum-pumping device incorporated with the cupping joint. The cupping 94, which is to be vacuum-pumped, is performed with the electrical vacuum-pumping device 1 for a vacuum-pumping work at an opening of the cupping 94. The suction nozzle 7 of the electrical vacuum-pumping device 1 is sleeved with and in a cupping joint 83, where the cupping joint 83 is dimensioned to match the cupping 94 and is made of silicon such that a preferable tightness can be obtained. Accordingly, upon inserting the cupping joint 83 into an opening of the cupping 94, a vacuum-pumping action can be performed by turning on the switch button 63.

Through the above design, according to the present invention, not only the electrical vacuum-pumping device 1 can be used directly, but also it can be applied to various products through the replaceable impermeable cup 81 or the joints 82, 83. This not only reduces expenses for users, but also enhances portability of the products, giving the users a feeling of worthiness more than money paid. In addition, customized joints are available in compliance with customer's usage habit.

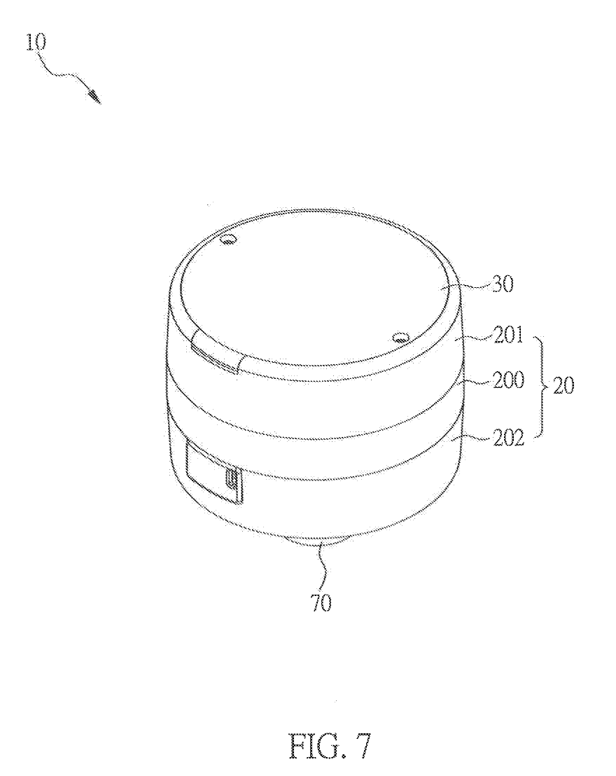

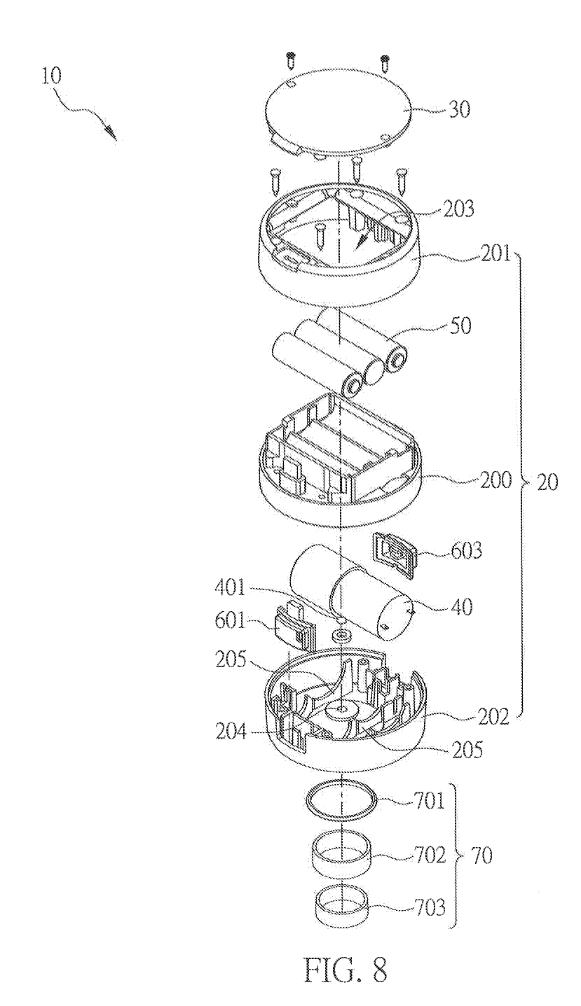

Further referring to FIG. 7, a perspective view illustrating an electrical vacuum-pumping device according to a second embodiment of the present invention; and to FIG. 8 is an exploded view illustrating the electrical vacuum-pumping device, the electrical vacuum-pumping device 10 comprises a primary structure body 20, an upper lid 30, an electrical vacuum pump 40, a power source 50, and a suction nozzle 70.

As shown in FIG. 7, the primary structure body 20 includes an upper body board 201, a middle body board 200, and a lower body board 202, which are fastened with one another. The middle body board 200 is interposed between the upper body board 201 and the lower body board 202, and is provided with an accommodating space 203 interiorly divided into two portions for receiving the electrical vacuum pump 40 and the power source 50. The lower body board 202 is provided with a suction hole 204 and a supporting base 205 for supporting the electrical vacuum pump 40. Further, the upper body board 201 is fastened with the upper lid 30; and that the lower body board 202 is provided, at its front side and rear side, with a notch, respectively, for mounting a charging panel engaging element 601 and a switch button 603, such that an overall casing structure of the electrical vacuum-pumping device 10, according to the present invention, can therefore be completed. According to the present invention, the charging panel engaging element 601 relates simply to a side-wall structure without having any relevant structure for a charging board; or even the charging panel engaging element 601 can be removed.

Thereafter, the following will be focused on a structural design of the primary structure body 20 and a spatial arrangement of the accommodating space 203. The electrical vacuum pump 40, which is arranged on the supporting base 205, is provided with a vacuum-pumping mouth 401 such that the vacuum-pumping mouth 401 extends into the suction hole 204. As such, air inside of an object to be vacuum-pumped can be pumped into the electrical vacuum pump 40, and then the air can be discharged through gaps around the notches of the primary structure body 20. Suction devices of air-pumping types are featured in miniaturization and low noise, and such devices can replace the conventional art which has the structure of motor with an eccentric wheel, let alone a higher portability is possible. Further, the power source 50, which is arranged on the middle body board 200, is electrically connected with the electrical vacuum pump 40. According to the present invention, the power source 50 relates to three alkaline batteries. The above-mentioned loading disposable batteries relate to a well-known manner of power supply, where such a battery has a dimension and weight greater than those of a lithium battery, though the design and structure are simpler and cost can be lowered.

According to the present invention, the lower body board 202 is fixedly arranged underneath with the suction nozzle 70, where the suction nozzle 70 includes an O-ring 701, a sealing washer 702, and a sealing washer liner 703 which enclose the suction hole 204, respectively. Both the sealing washer 702 and the sealing washer liner 703 are made of silicon. This will help improve tightness when in contact with the object to be vacuum-pumped so as to prevent air from coming in or out of the gaps of an attaching position during a vacuum-pumping work of the electrical vacuum-pumping device 10.

The manner of usage in the second embodiment is similar to that of the first embodiment, as referred to FIG. 3 to FIG. 6, though minor differences exist therebetween in terms of the manner of power supply and the appearance of structure, which will not be repeated redundantly.

Although the present invention has been explained in relation to its preferred embodiments, it is to be understood that many other possible modifications and variations can be made without departing from the scope of the invention as hereinafter claimed.

What is claimed is:

1. An electrical vacuum-pumping device, comprising:
a primary structure body, including an upper body board and a lower body board fastened with each other, and in which an accommodating space is provided, where the lower body board is provided with a suction hole;
an upper lid, covering on the upper body board;
an electrical vacuum pump, provided with a vacuum-pumping mouth and arranged in the accommodating space, where the vacuum-pumping mouth extends into the suction hole;
a power source, arranged in the accommodating space, and electrically connected with the electrical vacuum pump; and
a suction nozzle, arranged underneath to the lower body board, and enclosed the suction hole;
wherein, when in a state of use, the suction nozzle can engage directly with an object to be vacuum-pumped; or to engage an impermeable cup or a joint at one's option, and then to attach the same to the object to be vacuum-pumped.

2. The electrical vacuum-pumping device as claimed in claim 1, wherein the power source relates to a rechargeable battery, and the electrical vacuum-pumping device further comprises a charging panel, and the charging panel is inserted into a charging panel engaging element arranged at the primary structure, and is electrically connected with the power source.

3. The electrical vacuum-pumping device as claimed in claim 2, wherein the charging panel engaging element is provided with a charging slot.

4. The electrical. vacuum-pumping device as claimed in claim 3, wherein the charging slot relates to a USB slot.

5. The electrical vacuum-pumping device as claimed in claim 1, wherein the power source relates to a disposable battery.

6. The electrical vacuum-pumping device as claimed in claim 1, wherein the joint relates to a cork joint, or a cupping joint.

7. The electrical vacuum-pumping device as claimed in claim 1, Wherein the primary structure body is arranged with a switch button for controlling the electric vacuum pump.

8. The electrical vacuum-pumping device as claimed in claim 1, Wherein the primary structure body further includes a middle body board interposed between the upper body board and the lower body board.

9. The electrical vacuum-pumping device as claimed in claim 1, wherein the suction nozzle is made of silicon.
